(19) United States
(12) Patent Application Publication
(10) Pub. No.: US 2008/0163227 A1
(43) Pub. Date: Jul. 3, 2008

(54) SERVER AND CLIENT, AND UPDATE SUPPORTING AND PERFORMING METHODS THEREOF

(75) Inventors: Young-su SON, Seoul (KR); Sung Kim, Incheon (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/769,286

(22) Filed: Jun. 27, 2007

(30) Foreign Application Priority Data
Dec. 27, 2006 (KR) 2006-135565

(51) Int. Cl. G06F 9/46

(52) U.S. Cl. 718/102

(57) ABSTRACT

A server connected to a plurality of clients, the server including: a server interface unit to notify the clients of an update plan; a scheduling unit to generate an update schedule for each client transmitting a request for time assignment when the request for time assignment is received from each client notified of the update plan; and a control unit to support an update for each client according to the update schedule. Accordingly, the update of the clients connected to the server can be easily performed.

### CROSS-REFERENCE TO RELATED APPLICATION

This application claims the benefit of Korean Application No. 2006-135565, filed on Dec. 27, 2006, in the Korean Intellectual Property Office, the disclosure of which is incorporated herein by reference.

### BACKGROUND OF THE INVENTION

1. Field of the Invention

Aspects of the present invention relate to a server, a client, an update supporting method of the server, and an update performing method of the client, and more particularly, to a server, a client, and update supporting and performing methods thereof using a technique of assigning and scheduling an update time.

2. Description of the Related Art

The client/server model has become a main concept in network computing. Most business programs have been developed according to the client/server model. The client/server model is also applied to the TCP/IP, which is a major program of the Internet. For example, on the Internet, a web browser is a kind of a client program that requests a web server positioned somewhere on the Internet to send a web page or a file. In the general client/server model, when a server program (sometimes called “daemon”) is initially activated, the server program waits for a request from a client. Generally, a plurality of client programs shares one server program.

In the aforementioned client/server model, data transmission is generally performed by a polling mode and a push mode. In the polling mode, when clients periodically check a version of a server and update the version of the server, an update file is downloaded from the server. In this case, since clients periodically check the version of the server, both the server and the clients are overloaded. Moreover, all of the clients must keep the same version.

In the push mode, a server accesses an IP address of a client, based on client information managed by the server, and directly transmits data according to an option set by the client. However, if power of a client computer is off during the update or if the client ends during the update, the client update is impossible. Furthermore, the push method can be applied only when the IP address of a client is fixed.

### SUMMARY OF THE INVENTION

Aspects of the present invention relate to a server, a client, an update supporting method of the server, and an update performing method of the client, using a technique of assigning and scheduling an update time to minimize overload of the server and to enable proper update for all clients.

According to an aspect of the present invention, there is provided a server that is connected to one or more clients, the server including: a server interface unit to notify the clients of an update plan; a scheduling unit to generate an update schedule for each client transmitting a request for time assignment when the request for time assignment is received from each client; and a control unit to support an update for each client according to the update schedule.

The server may further include: a storage unit to store update software, and the control unit may transmit, to each client, an assigned update time for each client according to the update schedule, so that each client downloads the update software at the assigned update time.

The server may further include: a storage unit to store update software, and the control unit may transmit the update software to each client at an assigned update time for each client according to the update schedule.

The scheduling unit may additionally generate an update schedule for a client which transmits a request for new time assignment when the request for new time assignment is received while the update is supported according to the update schedule.

According to another aspect of the present invention, there is provided a client including: a client interface unit to connect to a server; a control unit to transmit a request for time assignment to the server and to receive an assigned update time; and an update processing unit to perform an update at the assigned update time.

The control unit may download update software from the server at the assigned update time, and the update processing unit may perform the update by using the downloaded update software.

The update processing unit may perform the update by using update software transmitted from the server at the assigned update time.

The control unit may determine whether the assigned update time has expired when a system of the client is rebooted, and re-transmit the request for time assignment to the server and receive a re-assigned update time if the assigned update time has expired.

The control unit may determine whether the update time has been assigned when the system of the client is rebooted, and transmit the request for time assignment to the server if the update time has not been assigned.

According to yet another aspect of the present invention, there is provided an update supporting method of a server connected to one or more clients, of the update supporting method including: generating an update schedule for each client transmitting a request for time assignment when the request for time assignment is received; and supporting an update for each client according to the update schedule.

The supporting of the update may include: transmitting, to each client, an assigned update time for each client according to the update schedule, so that each client downloads update software at the assigned update time.

The supporting of the update may include: transmitting update software to each client at the corresponding update time assigned to each of the clients.

The update supporting method may further include: generating an additional update schedule for a client that transmits a request for new time assignment when the request for new time assignment is received while the update is supported according to the update schedule.

According to another aspect of the present invention, there is provided an update performing method of a client connected to a server, the update performing method including: transmitting a request for time assignment to the server and receiving an assigned update time; and performing an update at the assigned update time.

The performing of the update may include: receiving information of the assigned update time; downloading update software from the server at the assigned update time; and performing the update by using the downloaded update software.

The performing of the update may include: receiving update software from the server at the assigned update time; and performing the update by using the received update software.

The update performing method may further include: determining whether a previously assigned update time has passed when a system of the client is rebooted; and re-transmitting a request for time assignment to the server if the update time has passed.

The update performing method may further include: determining whether the update time has been assigned when the system of the client has been rebooted; and transmitting a request for time assignment to the server and receiving an assigned update time when the update time has not been assigned.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of the configuration of a server according to an embodiment of the present invention;

FIG. 2 is a block diagram of the configuration of a server according to another embodiment of the present invention;

FIG. 3 is a block diagram of the configuration of a client according to an embodiment of the present invention;

FIG. 4 is a view illustrating an update performing process between a server and a client according to an embodiment of the present invention;

FIG. 5 is a flow chart explaining an update supporting method of a server according to an embodiment of the present invention;

FIG. 6 is a flow chart explaining an update supporting method according to an embodiment of the present invention;

FIG. 7 is a flow chart explaining an update supporting method according to another embodiment of the present invention; and

FIG. 8 is a flow chart explaining an update performing method of a client according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

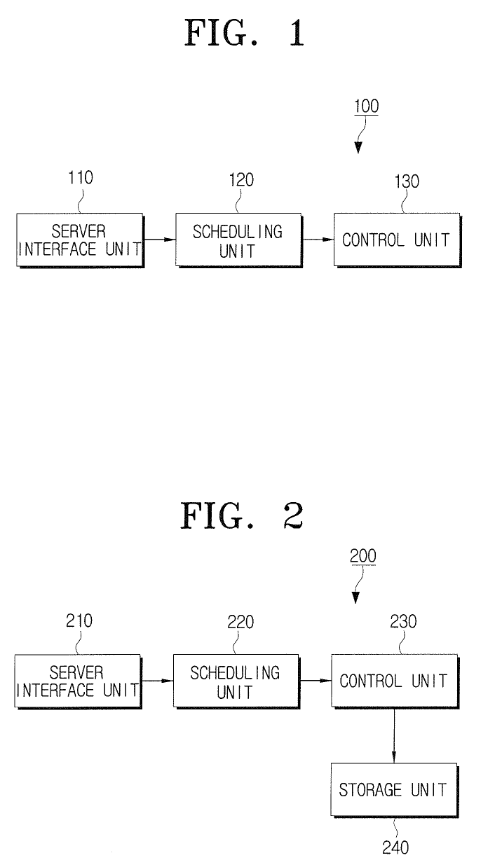

FIG. 1 is a block diagram of the configuration of a server according to an embodiment of the present invention. In FIG. 1, a server 100 includes a server interface unit 110, a scheduling unit 120, and a control unit 130. The server 100 is connected to clients (not shown) and uploads an update file to a specific client (not shown).

Here, the client/server model represents the role relationship formed between two computer programs. The client is a system requesting a service from another system, and the server is a system responding to the request of the client. The client/server model can be applied within a single computer but has a more significant meaning in network environments. The client/server model on the network provides a convenient way to connect programs that are scattered throughout many different regions. For example, in a home network system, the client (not shown) may be realized as a home device (such as a wall pad and the like) and the server 100 may be realized as a home server. Furthermore, the client (not shown) may be realized as an MP3 player, a mobile phone, and the like, and the server 100 may be realized as a relevant web server.

The server interface unit 100 notifies the clients of an update plan. Forms of notification include a message stating the existence of an update plan and a specific update time. When a new update file is added to the server 100, the server interface unit 110 notifies the relevant client (not shown) of an update plan.

The server interface unit 110 can be realized as any of various communication protocols (such as IEEE 1394, USB, and the like), depending on the network environments of the server 100 and the clients (not shown). The network environments can also be realized in various forms (such as the Internet, Intranet and the like). When the clients (not shown) are initially connected to the server 100, the server interface unit 100 can receive information of the clients connected to the server interface unit 110. Specifically, the server interface unit 100 can receive the Internet Protocol (IP) addresses of the clients. Here, the IP address is a unique address of each computer to be identified on networks connected throughout the world. The IP address is the unique ID of one computer to communicate with other computers.

When a request for time assignment is received from a client notified of the update plan by the server 100, the scheduling unit 120 generates an update schedule for each client transmitting the request for time assignment. The update time may be assigned at a predetermined time interval. For example, the update time may be 1000 ms after the update start for a first client, 200 ms after the update start for a second client, and 300 ms after the update start for a third client. Accordingly, an update for each client is enabled even though the synchronization activity between the server 100 and the clients or between the clients is not operated.

The scheduling unit 120 may generate the update schedule for each client in the order the clients are initially connected to the server 100, in the order of a predetermined priority, or in the order the requests for time assignment are received. Furthermore, as the case may be, the scheduling unit 120 may generate each independent update schedule depending on the state of each client.

When a request for new time assignment is received from any specific client after the update schedule is generated or the update according to the update schedule is performed, the scheduling unit 120 may generate an additional update schedule for the client that transmits the request for new time assignment or modify an existing update schedule for the client. For example, when a new request for time assignment is received from a client that missed the assigned update time due to a system stop or the like or when a request for time assignment is received from a client to which no update time was assigned due to a system stop or the like, the scheduling unit 120 may generate an additional update schedule for each client that transmits the request for new time assignment or modify an existing update schedule for the client.

The control unit 130 performs the whole control operation of each component of the server 100 and performs the update-related operations for the clients connected through the server interface unit 110. Specifically, the control unit 130 supports the update for the clients in various forms according to the update schedule generated by the scheduling unit 120.

FIG. 2 is a block diagram of the configuration of a server according to another embodiment of the present invention. In FIG. 2, a server 200 includes a server interface unit 210, a schedule unit 220, a control unit 230, and a storage unit 240. The repeated description of the same components illustrated in FIG. 2 as those of the embodiment illustrated in FIG. 1 will not be further presented.

The storage unit 240 stores update software, which includes data that can be transmitted to each client by the server 200 as the case may be.

The control unit 230 transmits, to each client, an assigned update time for each client according to an update schedule generated by the scheduling unit 220, so that each client with the assigned update time downloads the update software at the assigned update time.

When a download request for the update software is received from each client at the assigned update time for the client, the control unit 230 supports the client so that the client may download the update software. However, even if a specific client transmits the download request at the assigned update time for the client, the control unit 230 may be unable to support the download of the update software, depending on the state of the server 200.

The control unit 230 may actively transmit the update software to each client (as opposed to the client transmitting a download request) at the corresponding assigned update time according to the update schedule generated by the scheduling unit 220. Furthermore, even if no download request for the update software is received from each client at the assigned update time for the client, the control unit 230 may actively transmit, or attempt to transmit, the update software.

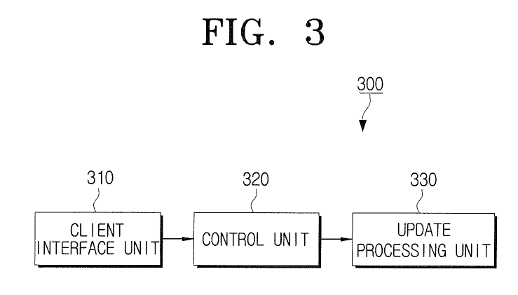

FIG. 3 is a block diagram of the configuration of a client according to an embodiment of the present invention. In FIG. 3, a client 300 includes a client interface unit 310, a control unit 320, and an update processing unit 330.

The client interface unit 310 is connected to a server (such as the server 100 illustrated in FIG. 1 or the server 200 illustrated in FIG. 2) in order to communicate with the server. The client interface unit 310 receives update-related information (such as an update plan, an update assignment time, update software, and the like) from the server. The client interface unit 310 may be realized in any of various communication protocols (such as IEEE 1394, USB, and the like) depending on the network environment of the server connected to the client interface unit 310.

The control unit 320 performs a general control operation of each component of the client 300 and, specifically, performs an update-related operation with the server connected through the client interface unit 310. When an update plan (or notification of an update plan) is received through the client interface unit 310, the control unit 320 transmits a request for time assignment to the server connected through the client interface unit 310 and receives an assigned update time. When the control unit 320 transmits the request for time assignment to the server, an IP address of the client 300 can be transmitted thereto. Here, the IP address of the client 300 may be a fixed IP address (for example, LAN and the like) or a variable IP address (for example, PPP connection and the like). When the client 300 has the fixed IP address, the server is generally able to access the client 300. However, when the client 300 has the variable IP address, the client 300 may send information of a changed IP to the server whenever the IP address is changed, so that the server may easily access the client 300.

The update processing unit 330 performs an update at the assigned update time. For example, the update processing unit 330 may install or update the update software that is received previously through the client interface unit 310. Also, the control unit 320 may download the update software from the server at the assigned update time. In this case, the update processing unit 330 performs the update by using the downloaded update software. Alternatively, the server may actively transmit the update software (as opposed to the client downloading the update software) at the assigned update time and the update processing unit 330 may perform the update by using the transmitted update software.

Furthermore, when a system of the client 300 is rebooted, the control unit 320 determines whether the previously assigned update time has expired. When the previously assigned update time has expired, the control unit 320 re-transmits a request for time assignment and receives a re-assigned update time. For example, when the system stops after the assigned update time is received through the client interface unit 310 and subsequently the system is rebooted before the assigned update time, this function of the control unit 320 is performed.

Similarly, when the system of the client 300 is rebooted, the control unit 320 determines whether the update time has been assigned. When the update time has not been assigned, the control unit 320 transmits a request for time assignment to the server and receives an assigned update time. For example, when the system stops before the update time is assigned and subsequently the system is rebooted, this function of the control unit 320 is performed.

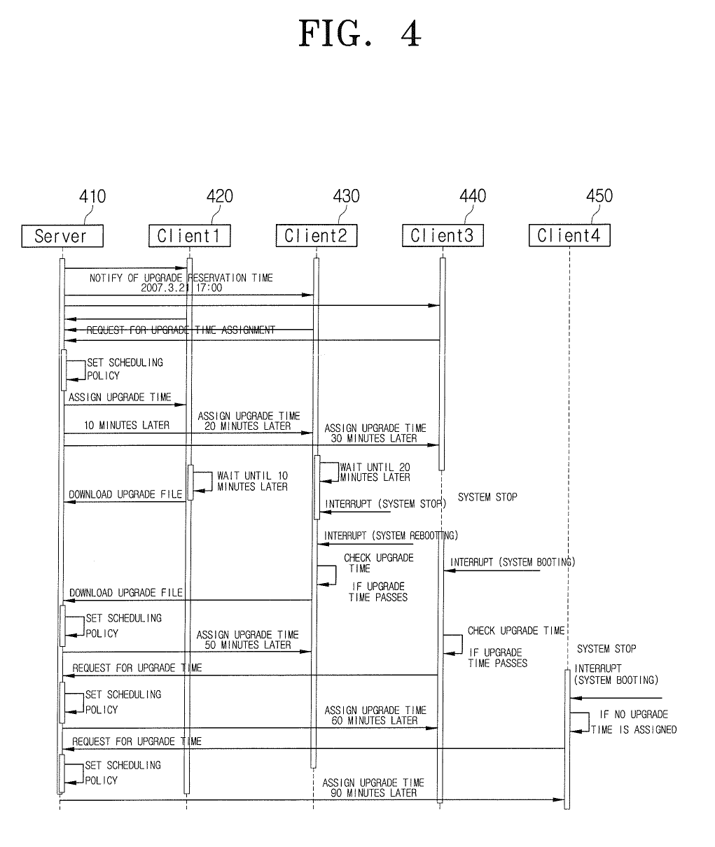

FIG. 4 is a view illustrating a process of performing an update between the server of FIG. 1 or 2 and the client of FIG. 3. In FIG. 4, a server 410 notifies clients 420, 430, 440, and 450 that are connected to the server 410 of an update plan. The notification of the update plan may be a specific reservation time (as shown in FIG. 4) or in a simple message to inform of the update plan. When the update plan notification includes the specific reservation time, the notification may be realized in various forms, such as 200612211240 (year: 2006, month: December, day: 21^{st}, hour: twelve, and minute: forty), 1000 ms (1000 ms after the delivery of the notification), and the like.

Among the clients 420, 430, 440, and 450 connected to the server 410, the clients 420, 430, and 440 notified of the update plan transmit requests for time assignment. Then, the server 410 assigns an update time to each of the clients 420, 430, and 440 requesting the time assignment. In this embodiment, the update time is assigned to be 10 minutes after the update starts for the first client 420, 20 minutes after the update starts for the second client 430, and 30 minutes after the update starts for the third client 430. However, it is understood that an assignment interval or a unit of an assigned time may be realized in forms other than ten minute intervals.

The first client 420 waits until the update time assigned from the server 410 and downloads an update file 10 minutes after the update starts. In the second client 430, a system of the second client 430 stops while waiting until the update time assigned from the server 410 (20 minutes after the update starts) or while upgrading. In this case, when the system is rebooted, the second client 430 checks whether the assigned update time has expired. If the assigned update time has expired, the second client 230 requests a new update time from the server 410. Subsequently, the second client 430 receives a newly assigned update time (50 minutes after the update starts) according to the scheduling of the server 410.

In the third client 440, the system stops immediately after receiving the update time (30 minutes after the update starts) assigned from the server 410. In this case, when a system of the third client 440 is booted, the third client 440 checks whether the assigned update time (30 minutes after the update starts) has passed. If the update time has passed, the third client 440 requests a new update time from the server 410. The third client 440 receives a newly assigned update time (60 minutes after the update starts) according to the scheduling of the server 410. The difference between the second client 430 and the third client 440 is that in the second client 430, the system is stopped by the user for a short time while waiting the upgrade time or upgrading, and in the third client 440 the system stops after the upgrade time is assigned.

In the fourth client 450, an update time is not assigned from the server 410 because a system of the fourth client 450 stops. In this case, when the system is booted, the fourth client 450 checks whether an assigned update time is present. If it is determined that no assigned update time is present, the fourth client 450 requests an update time from the server 410. Subsequently, the fourth client 450 receives an assigned update time (90 minutes after the update starts) according to the scheduling of the server 410.

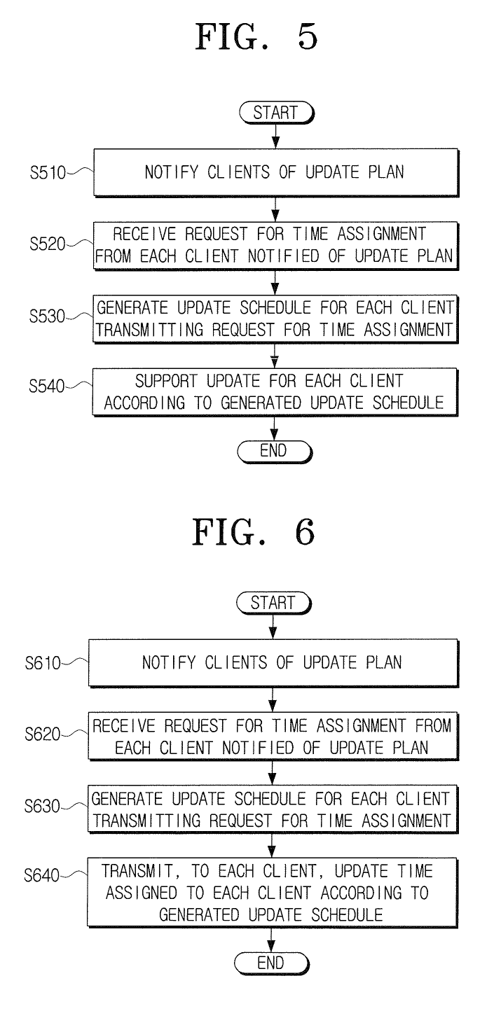

FIG. 5 is a flow chart explaining an update supporting method of a server (such as the server 100 illustrated in FIG. 1 or the server 200 illustrated in FIG. 2) according to an embodiment of the present invention. Referring to FIG. 5, first, a plurality of clients connected to a server is notified of an update plan in operation S510. A request for time assignment is received from each client notified of the update plan in operation S530. When the request for the time assignment is received from each client, an update schedule for each client transmitting the request for time assignment is generated in operation S530. Subsequently, updates for the clients are supported by the server according to the generated update schedule in operation S540.

Further, when a request for new time assignment is received while the updates are supported or performed according to the update schedule, the update schedule is modified or an additional update schedule is generated for the client transmitting the request for the new time assignment.

FIG. 6 is a view explaining, in detail, an example of the update supporting method of the server (such as the server 100 illustrated in FIG. 1 or the server 200 illustrated in FIG. 2) described with reference to FIG. 5 according to an embodiment of the present invention. Referring to FIG. 6, first, a plurality of clients connected to a server is notified of an update plan in operation S610. Then, a request for time assignment is received from each client notified of the update plan in operation S620. When the request for time assignment is received from each client, an update schedule for each client transmitting the request for time assignment is generated in operation S630. Subsequently, in operation S640, an update time assigned to each client according to the generated update schedule is transmitted to each client.

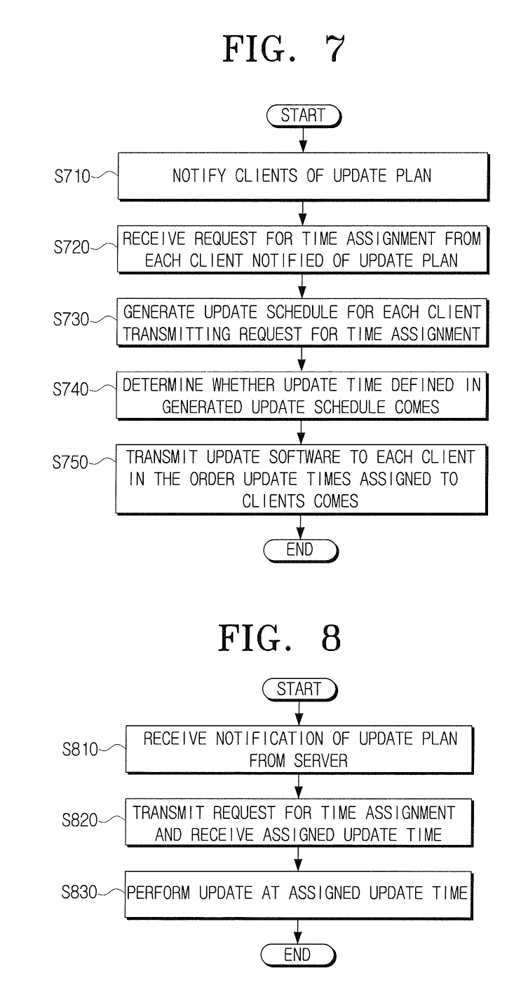

FIG. 7 is a view explaining, in detail, an example of the update supporting method of the server described with reference to FIG. 5 according to another embodiment of the present invention. Referring to FIG. 7, first, a plurality of clients connected to a server is notified of an update plan. Then, a request for time assignment is received from each client notified of the update plan in operation S720. When the request for time assignment is received from each client, an update schedule for each client transmitting the request for time assignment is generated in operation S730. Subsequently, in operation S740, it is determined whether an update time defined according to the generated update schedule passes. In operation S750, update software is transmitted to each client as each update time passes.

FIG. 8 is a flow chart explaining an update performing method of a client according to an embodiment of the present invention. Referring to FIG. 8, first, a server notifies a client of an update plan in operation S810. Then, a request for time assignment is transmitted to the server and an update time is assigned to the client in operation S820. Subsequently, in operation S830, an update is performed at the assigned update time.

When a system of the client is rebooted, it is determined whether a previously assigned update time has passed. As a result, if it is determined that the previously assigned update time has passed, a request for time assignment is re-transmitted to the server, so that an update time is re-assigned to the client.

Similarly, when the system of the client is rebooted, it is determined whether an update time has been assigned to the client. If the update time has not been assigned, a request for time assignment is transmitted to the server, so that an update time is assigned to the client.

According to another aspect of the present invention, after receiving information of the assigned update time (operation S820), the client downloads update software from the server at the assigned update time. Alternatively, the client may receive the update software from the server at the assigned update time. Subsequently, the client performs the update by using the downloaded update software (operation S830). Accordingly, the clients connected to the server can accurately and easily perform the update.

As described above, according to aspects of the present invention, performing an update is possible for all of the clients connected to the server, and overload of the server is prevented by using the scheduling policy of the server. Furthermore, a version of the update that each client desires can be performed for each client. Therefore, a user's convenience is greatly improved.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, optical data storage devices, and a computer data signal embodied in a carrier wave comprising a compression source code segment comprising the code and an encryption source code segment comprising the code (such as data transmission through the Internet). The computer-readable recording medium can also be distributed over network-coupled computer systems so that the computer-readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A server that is connected to one or more clients, the server comprising:
a scheduling unit to generate an update schedule for each client transmitting a request for time assignment when the request for time assignment is received from each client; and
a control unit to support an update for each client transmitting the request for time assignment according to the corresponding update schedule for each client.

2. The server as claimed in claim 1, further comprising:
a server interface unit to notify the one or more clients of an update plan.

3. The server as claimed in claim 1, wherein the control unit transmits, to each client transmitting the request for time assignment, an update time assigned according to the update schedule for each client such that the control unit supports the update for each client at the corresponding assigned update time.

4. The server as claimed in claim 3, further comprising:
a storage unit to store update software,
wherein each client downloads the update software at the corresponding assigned update time.

5. The server as claimed in claim 3, further comprising:
a storage unit to store update software,
wherein the control unit transmits the update software to each client at the corresponding assigned update time.

6. The server as claimed in claim 1, wherein the scheduling unit generates an additional update schedule for a first client transmitting a request for new time assignment after the scheduling unit generates the update schedule for each client transmitting the request for time assignment.

7. A client comprising:
a client interface unit to connect to a server;
a control unit to transmit a request for time assignment to the server and to receive an assigned update time; and
an update processing unit to perform an update at the assigned update time.

8. The client as claimed in claim 7, wherein the control unit transmits the request for time assignment to the server when an update plan is received or detected through the client interface unit.

9. The client as claimed in claim 7, wherein the control unit downloads update software from the server at the assigned update time, and the update processing unit performs the update by using the downloaded update software.

10. The client as claimed in claim 7, wherein the server transmits update software at the assigned update time, and the update processing unit performs the update by using the transmitted update software.

11. The client as claimed in claim 7, wherein the control unit determines whether the assigned update time has passed when a system of the client is rebooted, and re-transmits the request for time assignment to the server and receives a re-assigned update time if the assigned update time has passed.

12. The client as claimed in claim 7, wherein the control unit determines whether the update time has been assigned when a system of the client is rebooted, and transmits a new request for time assignment to the server when the update time has not been assigned.

13. An update supporting method of a server connected to one or more clients, the update supporting method comprising:
generating an update schedule for each client transmitting a request for time assignment when the request for time assignment is received from each client; and
supporting an update for each client transmitting the request for time assignment according to the corresponding update schedule for each client.

14. The update supporting method as claimed in claim 13, wherein the supporting of the update comprises:
transmitting, to each client transmitting the request for time assignment, an update time assigned according to the update schedule for each client; and
supporting the update for each client at the corresponding assigned update time.

15. The update supporting method as claimed in claim 14, wherein the supporting of the update further comprises:
transmitting update software to each client at the corresponding assigned update time.

16. The update supporting method as claimed in claim 13, further comprising:
generating an additional update schedule for a first client transmitting a request for new time assignment after the generating of the update schedule for each client transmitting the request for time assignment.

17. A computer readable recording medium encoded with the method of claim 13 implemented by a computer.

18. An update performing method of a client connected to a server, the update performing method comprising:
transmitting a request for time assignment to the server and receiving an assigned update time; and
performing an update at the assigned update time.

19. The update performing method as claimed in claim 18, wherein the transmitting of the request for time assignment comprises:
transmitting the request for time assignment to the server when an update plan is received or detected from the server.

20. The update performing method as claimed in claim 18, wherein the performing of the update comprises:
downloading update software from the server at the assigned update time; and
performing the update by using the downloaded update software.

21. The update performing method as claimed in claim 18, wherein the performing of the update comprises:
receiving update software from the server at the assigned update time; and
performing the update by using the received update software.

22. The update performing method as claimed in claim 18, further comprising:
determining whether the assigned update time has passed when a system of the client is rebooted; and
re-transmitting the request for time assignment to the server and receiving a re-assigned update time if the assigned update time has passed.

23. The update performing method as claimed in claim 18, further comprising:
determining whether the update time has been assigned when a system of the client is rebooted; and
transmitting a new request for time assignment to the server when the update time has not been assigned.

24. A computer readable recording medium encoded with the method of claim 18 implemented by a computer.
